(19) United States
(12) Patent Application Publication
(10) Pub. No.: US 2004/0225966 A1
(43) Pub. Date: Nov. 11, 2004

(54) Method and device for automatically displaying appointments

(75) Inventors: Mohammad Besharat, Boynton Beach, FL (US); Diana Arboleda, Delray Beach, FL (US); Faisal Haidar, Lake Worth, FL (US)

Correspondence Address: FLEIT, KAIN, GIBBONS, GUTMAN, BONGINI, & BIANCO P.L., 551 N.W. 77TH STREET, SUITE 111, BOCA RATON, FL, 33487, US

(73) Assignee: MOTOROLA, INC., SCHAUMBURG, IL

(21) Appl. No.: 10/435,333

(22) Filed: May 9, 2003

(51) Int. Cl. G09G 5/00; G04B 47/00; G04B 25/00

(52) U.S. Cl. 715/705; 368/10; 368/223

(57) ABSTRACT

A method and a device (100) for displaying appointments includes: displaying an analog clock face (202) divided into a plurality of time regions, such as twelve hour intervals, on the display (109); associating time regions, such as the twelve hour intervals with appointments; and marking the associated time regions (204, 206, 208) thereby visually indicating appointments. In one embodiment, marking includes using one or more of pattern, color, hue, gray scale, and image features.

### BACKGROUND OF THE INVENTION

1. Field of the Invention

The present invention generally relates to calendar displays and more particularly relates to methods and devices for automatically displaying appointments.

2. Description of the Related Art

Graphical user interfaces (GUI) are becoming increasingly popular with users of electronic devices such as computers, wireless telephones and personal digital assistants (PDAs). Computers with graphical user interfaces facilitate use, allowing one to quickly learn to use an application program in a GUI based environment.

These electronic devices (i.e., computers and wireless telephones) incorporating GUIs can perform a variety of tasks and execute a wide variety of applications. Some of the applications enable users of these devices to manage scheduling and other related tasks. The application programs, for example, can include calendar and scheduling programs. Most electronic devices include real-time clocks, which provide time and date information. The real-time clocks are useful for date and time stamping documents, and also for providing current date and time information to application programs such as appointment-calendars.

Some commercial applications in various devices include scheduling and calendar features and functions. However, users of these devices have to typically manipulate through user interface menus and submenus and multiple screen displays every time they need to view, for example, their appointments and task deadlines in the calendar. People endeavoring to complete work before a deadline often repeatedly have to access the user interface menus and submenus to keep track of tasks and appointments, which unfortunately consumes precious time during time-critical events, as well as imposing significant inconvenience to users.

Moreover, the small physical size of today's portable electronic devices such as wireless telephones, PDAs, electronic organizers, and other messaging devices pose problems in adapting the small user interfaces of such devices to the scheduling and calendar applications. First of all, limited space for user inputs, such as keys and buttons, can intensify the challenges of navigating through menus and multiple display screens. User buttons and selection choices are often too small to be easily selectable with a user's finger, stylus or other pointing devices. Secondly, it can be very difficult to display large amounts of information on portable electronic devices because of limited display screen sizes. In the case of multiple appointments, for example, the space available to legibly display all of the appointments is greatly reduced or may not be available. Thirdly, users of electronic devices may forget to view their calendars manually when they are busy doing other tasks, because the limited display screen sized are typically filled with other information rather than scheduling and calendar features and functions being displayed to the user. Thus, regrettably, the users may miss their appointments.

### SUMMARY OF THE INVENTION

According to a preferred embodiment of the present invention, a method for displaying appointments on a display in an electronic device includes: displaying an analog clock face divided into a plurality of time regions on the display; determining time regions on the analog clock face with at least one appointment being indicated in at least one of the displayed plurality of time regions; and marking the determined time regions.

According to a further embodiment of the present invention, a graphical user interface (GUI) contains an analog clock face divided into a plurality of time regions having marked occupied time regions therein; and a title representative of a calendar appointment related to the analog clock face.

### BRIEF DESCRIPTION OF THE DRAWINGS

The accompanying figures, where like reference numerals refer to identical or functionally similar elements throughout the separate views and which together with the detailed description below are incorporated in and form part of the specification, serve to further illustrate various embodiments and to explain various principles and advantages all in accordance with the present invention.

FIG. 1 is a block diagram of an electronic device.

FIG. 2 is an illustration of an analog clock face on a display such as a screen of the electronic device of FIG. 1.

FIGS. 3 through 5 are exemplary operational flow diagrams illustrating operations of the electronic device of FIG. 1.

### DETAILED DESCRIPTION OF THE PREFERRED EMBODIMENT(S)

General:

As required, detailed embodiments of the present invention are disclosed herein; however, it is to be understood that the disclosed embodiments are merely exemplary of the invention, which can be embodied in various forms. Therefore, specific structural and functional details disclosed herein are not to be interpreted as limiting, but merely as a basis for the claims and as a representative basis for teaching one skilled in the art to variously employ the present invention in virtually any appropriately detailed structure. Further, the terms and phrases used herein are not intended to be limiting; but rather, to provide an understandable description of the invention.

The terms a or an, as used herein, are defined as one or more than one. The term plurality, as used herein, is defined as two or more than two. The term another, as used herein, is defined as at least a second or more. The terms including and/or having, as used herein, are defined as comprising (i.e., open language). The term coupled, as used herein, is defined as connected, although not necessarily directly, and not necessarily mechanically. The terms program, software application, and the like as used herein, are defined as a sequence of instructions designed for execution on a computer system. A program, computer program, or software application may include a subroutine, a function, a procedure, an object method, an object implementation, an executable application, an applet, a servlet, a source code, an object code, a shared library/dynamic load library and/or other sequence of instructions designed for execution on a computer system. Reference throughout the specification to “one embodiment” means that a particular feature, structure, or characteristic described in connection with the embodiment is included in at least one embodiment of the present invention. Thus, the appearances of the phrases “in one embodiment” in various places throughout the specification are not necessarily all referring to the same embodiment. Furthermore, the particular features, structures, or characteristics may be combined in any suitable manner in one or more embodiments. Moreover these embodiments are only examples of the many advantageous uses of the innovative teachings herein. In general, statements made in the specification of the present application do not necessarily limit any of the various claimed inventions. Moreover, some statements may apply to some inventive features but not to others. In general, unless otherwise indicated, singular elements may be in the plural and visa versa with no loss of generality.

Terminology of Regions and Marking:

Accordingly, in order to make electronic devices more user-friendly without increasing the cost of the devices, a preferred embodiment of the present invention marks displayed regions associated with the hours or other time increments of an analog clock. The present invention visually indicates upcoming appointments or other events that occur at (or that are occurring over) those marked hours (or time increments). One preferred embodiment of present invention visually indicates upcoming appointments or other events occurring over the next twelve-hour period. The term “region” as used in the present discussion means any displayed indication of time period that is associated with an embodiment of an analog clock display. For example, a time period or region on an analog clock display may comprise a displayed triangular symbol, or wedge, that indicates a span of time or a time period that can be displayed on an analog clock display. Typically, this time period may be up to twelve hours in duration. Other displayed indications of time period or regions may comprise geometric shapes, such as rectangular shapes, triangular shapes, and circular shapes, and other polygon shapes that are associated with the time indications on an analog clock display. Further, displayed indications of time period or regions may also comprise linear, curvilinear, and/or disjointed line symbols or grouping of symbols, associated with the time indications on an analog clock display. Of course, it should become obvious to those of ordinary skill in the art, in view of the present discussion, that there are many alternative embodiments of regions associated with an analog clock display.

The term “mark” as used in the present discussion is any highlighting, illumination, and/or emphasis added to any region or area of the analog clock display including but not limited to emphasizing, intensifying, underlining and underscoring. This helps the user to see his/her immediate appointments. Marking includes using features such as color change, varying gray scale, setting background, pattern and image features, or an equivalent.

Exemplary Embodiment Of An Electronic Device:

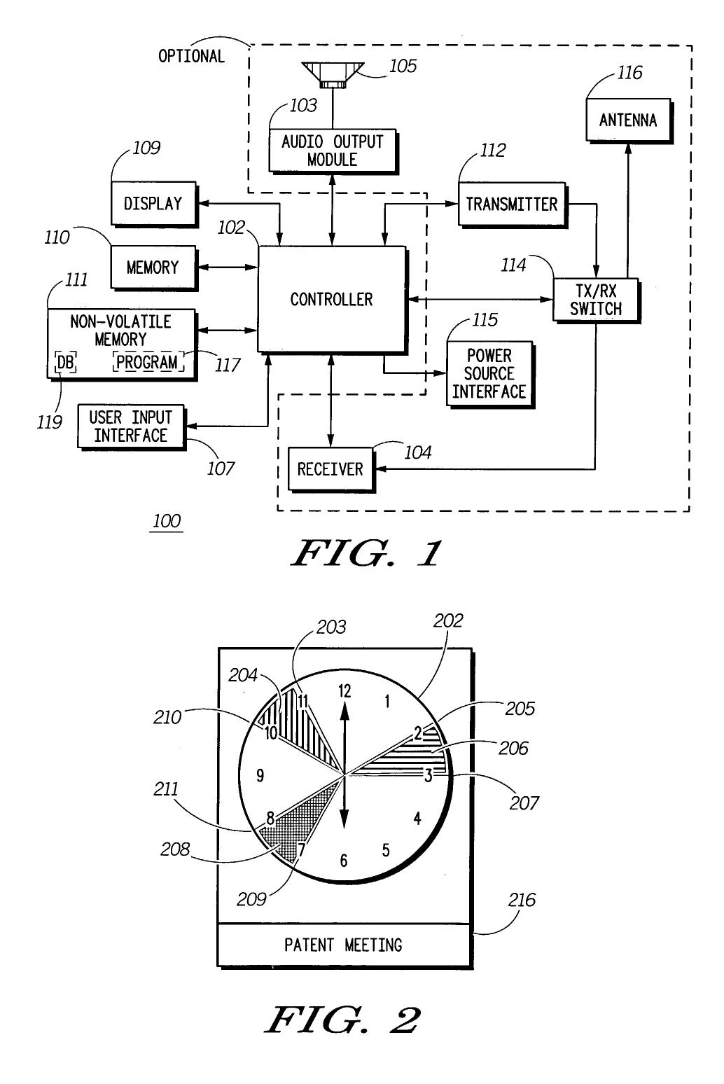

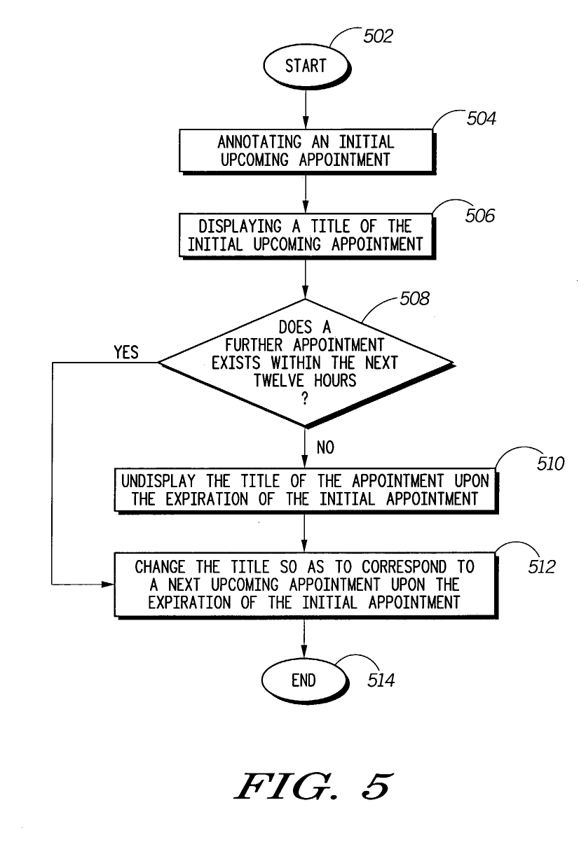

Described now is an exemplary hardware platform for carrying out the present invention using flow diagrams of FIGS. 3-5. Referring to FIG. 1, the electronic device 100 is any device 100 with a display including a wireless telephone, PDA, computer, electronic organizer, and other messaging device, and an electronic timepiece. The electronic device 100 includes a controller 102, a memory 110, a non-volatile (program) memory 111 containing at least one application program 117 and at least one database/file 119 a power source (not shown) through a power source interface 115. The database/file 119 stores records having various fields related to features of the application program 117, as will be discussed in more detail below.

In one embodiment, the application program 117 comprises a calendar-scheduling program. In this embodiment, the database/file 119 stores records corresponding to the calendar-scheduling features of the application program 117. Exemplary operational sequences of the application program 117 are described below with reference to FIGS. 3-5.

The device 100, in this example is a wireless communication device. The wireless communication device transmits and receives signals for enabling a wireless communication such as for a cellular telephone, in a manner well known to those of ordinary skill in the art. For example, when the wireless communication device 100 is in a “receive” mode, the controller 102 controls a radio frequency (RF) transmit/receive switch 114 that couples an RF signal from an antenna 116 through the RF transmit/receive (TX/RX) switch 114 to an RF receiver 104, in a manner well known to those of ordinary skill in the art. The RF receiver 104 receives, converts, and demodulates the RF signal, and then provides a baseband signal, for example, to audio output module 103 and a transducer 105, such as speaker, in the device 100 to provide received audio to a user. The receive operational sequence is under control of the controller 102, in a manmer well known to those of ordinary skill in the art.

In a “transmit” mode, the controller 102, for example responding to a detection of a user input (such as a user pressing a button or switch on a user interface 107of the device 100), controls the audio circuits and a microphone interface (not shown), and the RF transmit/receive switch 114 to couple audio signals received from a microphone to transmitter circuits 112 and thereby the audio signals are modulated onto an RF signal and coupled to the antenna 116 through the RF TX/RX switch 114 to transmit a modulated RF signal into a wireless communication system (not shown). This transmit operation enables the user of the device 100 to transmit, for example, audio communication into the wireless communication system in a manner well known to those of ordinary skill in the art. The controller 102 operates the RF transmitter 112, RF receiver 104, the RF TX/RX switch 114, and the associated audio circuits (not shown), according to instructions stored in the program memory 111.

Further, the controller 102 is communicatively coupled to a user input interface 107 (such as a key board, buttons, switches, and the like) for receiving user input from a user of the device 100. It is important to note that the user input interface 107 in one embodiment is incorporated into the display 109 as “GUI (Graphical User Interface) Buttons” as known in the art. The user input interface 107 preferably comprises several keys (including function keys) for performing various functions in the device 100. In another embodiment the user interface 107 includes a voice response system for providing and/or receiving responses from the device user. In still another embodiment, the user interface 108 includes one or more buttons used to generate a button press or a series of button presses such as received from a touch screen display or some other similar method of manual response initiated by the device user. The user input interface 107 couples data signals (to the controller 102) based on the keys depressed by the user. The controller 102 is responsive to the data signals thereby causing functions and features under control of the controller 102 to operate in the device 100. The controller 102 is also communicatively coupled to a display 109 (such as a liquid crystal display) for displaying information to the user of the device 100.

The present invention can be realized in hardware, software, or a combination of hardware and software. The present invention can also be embedded in a computer program product, which comprises all the features enabling the implementation of the methods described herein, and which—when loaded in the device 100—is able to carry out these methods.

Optional Wireless Interfaces:

In one embodiment, the device 100 implements a wireless interface (not shown) includes a Bluetooth wireless interface, a serial infrared communications interface (“SIR”), a Magic Beam interface and other low power small distance wireless communication interface solutions, as are well known to those of ordinary skill in the art.

The use of these optional wireless interfaces permits the database/file 119 and/or program 117 to the device 100 to be modified, updated and programmed remotely. This is particularly important in applications where the device 100 is synchronized with an external application such as a calendaring-scheduling program running on a desktop computer.

Analog Clock Display:

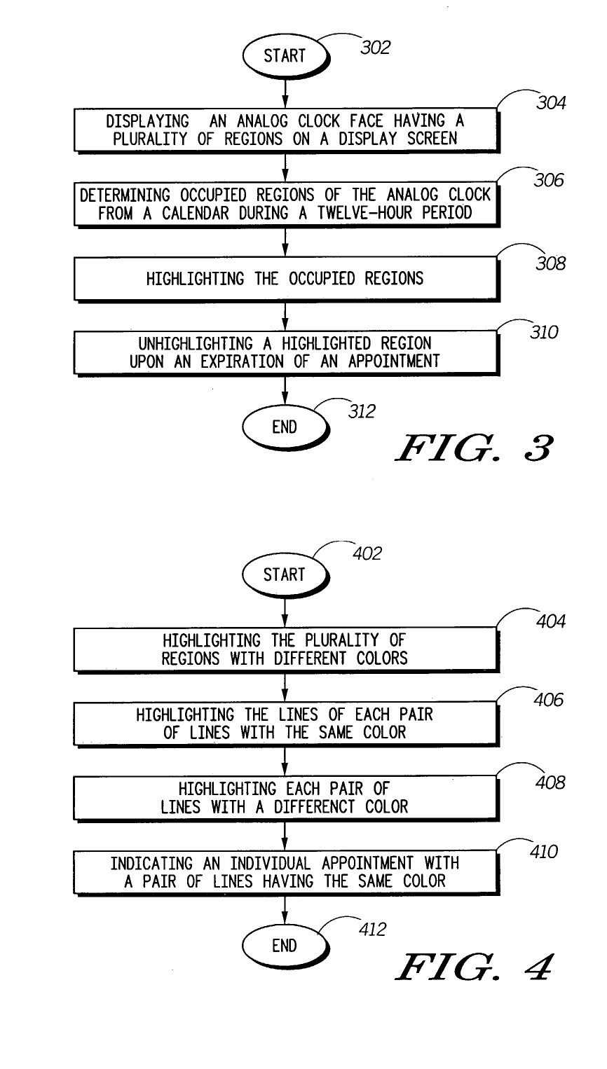

Turning now to FIG. 2 an exemplary 12-hour clock face 202 is displayed on the display 109 under the control of the controller 102. The exemplary clock interface 202 includes, inter alia, twelve-hour regions, starting from hour 1 and ending at hour 12.

For example, in one embodiment, the current time is 6:00 AM and the following three appointments are already entered into the calendar 117, which are stored as records in the database/file 119, of the device 100:

1) Appointment #1 is from 10:00 to 11:00 AM—region 204.

2) Appointment #2 is from 2:00 to 3:00 PM—region 206.

3) Appointment #3 is from 7:00 PM to 8:00 PM—region 208.

Regions 204, 206, and 208 in this embodiment are delineated by a set of lines as follows:

Region 204—lines 210 and 203.

Region 206—lines 205 and 207.

Region 208—lines 209 and 211.

These sets of delineations are optional. Moreover, the type of delineation, the display indicators such as lines, the markings and the shape of the regions are changeable within the true scope and spirit of the present invention as described in the section above “Terminology of Regions and Marking:.”

However, in other exemplary embodiments, the time intervals of the appointments may include smaller time intervals such as minutes and seconds.

In addition, other suitable clock faces 202 can be used. These include, for example, a square, a rectangle, a circle and an oval shape. Alternative embodiments of regions for the clock faces 202 may also be implemented as should be obvious to those of ordinary skill in the art in view of the discussion above. Thus, as explained above, the analog clock face 202 and the alternative implementations of regions associated with the analog clock face 202 provides an efficient way of communicating data such as scheduled appointments to a user of the device 100.

Flow Diagram Embodiments:

When the user enters an appointment into the device 100, an exemplary application program 117 receives input data. These database/file 119 entries in the exemplary table below are preferably entered directly through the user interface 107. Optionally, through a remote device such as a desktop computer communicating over an optional wireless interface can be used to enter data into the database/file 119. Accordingly, each record is associated with an appointment. Three exemplary records for a twelve hour period are shown in the table below:

| Appointment | | | | |
|---|---|---|---|---|
| Number | | | Title | Remarks |
| (Optional) | Start Time | Stop Time | (Optional) | (Optional) |
| 1 | 10 AM | 11 AM | | Phone Call |
| 2 | 2 PM | 3 PM | PATENT | Room C232 |
| | | | MEETING | |
| 3 | 7 PM | 8 PM | | Indian Restaurant |

The “Appointment Number” is an optional sequence number filled in each record of the database/file 119. The “Start Time” is the time to begin the appointment. The “Stop Time” is the time the appointment ends. In another embodiment the “Stop Time” is replaced by a duration (not shown). Two optional fields “Title” for presenting a title of the appointment and a “Remarks” entry for holding comments such as location of the meeting are shown.

Flow Diagram Embodiment for Gray Scale:

The following flow diagram is particularly suited to display on black and white or gray scale displays 109. It should be understood that color displays 109 are also suited for this embodiment as well. The process flow begins at step 302 and immediately proceeds to step 304 where the controller 102 along with application program 117, such as calendar-scheduling program, displays a clock face such as clock face 202. As described above records in database/file 119 represent appointments in a twelve-hour period. Next in step 306, the process determines the scheduled or occupied time periods during a twelve-hour period previously associated with the one or more records of the database/file 119. The records in the database/file 119 are read by controller 102 and used to subsequently denote appointments on the clock face 202. Then, at step 308, the controller 102 marks the scheduled or occupied regions 204, 206, 208, and displays the corresponding regions 204, 206 and 208 of the analog clock 202 in a marked or highlighted manner, as shown in FIG. 2. In alternative embodiments, marking may include any combination of the following marking or highlight features such as hues, gray scale, background, pattern and images.

At step 310, the controller 102 unmarks a previously marked region (e.g., 204) upon an expiration of a corresponding appointment (e.g., 10-11 AM) and this process flow ends with step 312. By unmarking a previously marked region, it visually indicates to a user of the device 100 that an appointment has either lapsed or has been removed from the database/file 119.

Flow Diagram Embodiment for Color:

The following flow diagram is particularly suited for use with color displays 109. In this embodiment as shown in FIG. 4, the process begins with step 402 and proceeds to step 404 for marking the occupied regions 204, 206, 208 with different colors (e.g., green, red and blue). Step 406 involves marking the lines (203, 210) of each pair of lines (203, 210) with the same color (e.g., green). In alternative embodiments, marking may include any combination of marking and highlighting features such as hues, gray scale, background, pattern and images.

In this exemplary embodiment at step 404, the marked region 204 of the appointment preferably returns to the standard or background color (i.e., not marked anymore) upon the expiration of the appointment. This visually indicates to a user both when appointments are pending and when appointment have expired and no longer pending. This is additionally useful for user of the device 100.

Step 408 entails marking each pair of lines 203, 210; 205, 207; 209, 211 with a different color (e.g., green, red and blue). Thus, various pairs of lines are marked with different colors. For example, the region 204 is indicated with a pair of green lines 210, 203. The region 206 is indicated with a pair of red lines 205, 207. The region 208 is indicated with a pair of blue lines 209, 211. Accordingly, the three different pairs of lines are marked in different colors to indicate three different appointments during three time periods.

In step 410, each set (pair) of lines (e.g., 210, 203) with the same color (e.g., green) indicates an individual appointment (e.g., appointment #1: 10-11 AM) and the process ends in step 412.

It is important to note that each set (pair) of lines described above may be marked with the same color or different colors to bound an appointment region on the clock face 202, within the true scope and spirit of the present invention. Moreover, each set (pair) of lines may be presented in a color, which is different from other sets (pairs) of lines.

Flow Diagram Embodiment for Displaying a Title of a Meeting:

The following flow diagram is particularly suited to display a title previously associated with a meeting in a record in the database/file 119. In this exemplary embodiment annotating an initial upcoming appointment with an optional title 216 is shown in FIG. 5. The process starts at step 502 and immediately proceeds to step 504 where an initial upcoming appointment is marked or annotated. Continuing at step 506 the title 216 of the immediately next upcoming appointment (e.g., PATENT MEETING) is displayed on the display 109. This optional title is stored as a record in the database/file 119. The title is preferably displayed in a predefined region on the display 109 for displaying title information to a user of the device 100. For example, a panel or window in the display 109 may be used to continuously display the title of the immediately next upcoming appointment. In this way, a user of the device 100 will be more fully informed of the next appointment, both its start time, duration, and a brief title description.

At step 508, the controller 102 determines if a further upcoming appointment exists within the next twelve hours of the expiration of the initial appointment.

If a further upcoming appointment does not exist, then step 510 involves undisplaying (i.e., removing) the title of the appointment upon the expiration of the initial appointment.

If a further upcoming appointment exists, then step 512 involves changing the title (upon the expiration of the initial appointment) so as to correspond to the next upcoming appointment and the process end in step 514.

Conclusions:

The aforementioned features are very user-friendly, since the user does not have to take any action in order to view appointments on the idle display 109 during the next twelve-hour period. Accordingly, preferred embodiments of the present invention, as discussed above, provide the user with an efficient way of viewing the schedule.

Although specific embodiments of the invention have been disclosed, those having ordinary skill in the art will understand that changes can be made to the specific embodiments without departing from the spirit and scope of the invention. The scope of the invention is not to be restricted, therefore, to the specific embodiments, and it is intended that the appended claims cover any and all such applications, modifications, and embodiments within the scope of the present invention.

What is claimed is:

1. A method within an electronic device for displaying appointments, the method comprising:
displaying an analog clock face divided into a plurality of time regions on the display;
associating at least one of the plurality of time regions with at least one appointment; and
marking one time region of the plurality of time regions to visually indicate at least one appointment being associated with the one time region.

2. The method of claim 1, wherein the plurality of time regions comprises one or more geometric shapes chosen from a group consisting of rectangles, triangles, squares, circles and polygons, associated with time intervals on the analog clock face.

3. The method of claim 1, wherein the plurality of time regions comprises one or more time regions chosen from a group consisting of minute regions and hour regions.

4. The method of claim 1, wherein each of the plurality of time regions is marked with a first background.

5. The method of claim 1, wherein marking one time region includes one or more markings chosen from a group consisting of pattern, color, hue, gray scale, and image.

6. An electronic device comprising:
a display for displaying appointments; and
a controller communicatively coupled with the display and configured for:
displaying an analog clock face divided into a plurality of time regions on the display;
determining time regions with appointments therein from a calendar; and
marking the determined time regions on the display.

7. The electronic device of claim 6, wherein the analog clock face comprises one or more geometric shapes chosen from a group consisting of a circle, an oval, a square and a rectangle.

8. The electronic device of claim 6, wherein the controller is further configured for marking the determined time regions with one or more markings chosen from a group consisting of pattern, color, hue, gray scale and image.

9. The electronic device of claim 6, wherein each of the plurality of regions is bounded by a pair of lines indicating a start time and an end time of an appointment.

10. The electronic device of claim 9, wherein the lines of each pair of lines are marked with a first color.

11. The electronic device of claim 9, wherein a first line in each pair of lines is marked with a first color and a second line in each pair of lines is marked with a second color.

12. The electronic device of claim 9, wherein each individual appointment is indicated using a pair of lines comprising one color.

13. The electronic device of claim 12, wherein a first individual appointment is indicated using a pair of lines comprising a first color and a second individual appointment is indicated using a pair of lines comprising a second color.

14. The electronic device of claim 6, wherein the controller is further configured for:
annotating at least one of a current and an upcoming appointment.

15. The electronic device of claim 14, wherein the controller is further configured for:
displaying a title of the upcoming appointment.

16. The electronic device of claim 15, wherein the controller is further configured for:
undisplaying the title of the appointment upon an expiration of the initial appointment if no further upcoming appointment exists within the next twelve hours.

17. The electronic device of claim 15, wherein the controller is further configured for:
changing the title so as to correspond to a next upcoming appointment upon an expiration of the initial appointment if a further upcoming appointment exists within the next twelve hours.

18. The electronic device of claim 6, wherein the controller is further configured for:
unmarking a marked region upon an expiration of an appointment.

19. The electronic device of claim 6, wherein the clock face represents at least one of a twelve hour time period and a twenty-four hour time period.

20. A computer readable medium comprising computer instructions for displaying appointments on a display in an electronic device, the computer instructions comprising instructions for:
displaying an analog clock face divided into a plurality of time regions on the display;
determining time regions with appointments therein from a calendar; and marking the determined time regions.

21. The computer readable medium of claim 20, wherein marking comprises one or more markings consisting of pattern, color, hue, gray scale and image.

22. A graphical user interface (GUI) in an electronic device, comprising:
an analog clock face divided into a plurality of time regions having marked occupied time regions therein; and
a title representative of a calendar appointment related to the analog clock face.

23. The graphical user interface (GUI) of claim 22, wherein the title changes with each calendar appointment.
